(19) United States
(12) Patent Application Publication
(10) Pub. No.: US 2010/0222016 A1
(43) Pub. Date: Sep. 2, 2010

(54) WIRELESS COMMUNICATION DEVICE

(75) Inventors: Kazushige KISHIGAMI, Kawasaki (JP); Manabu MURAKAMI, Kawasaki (JP); Masahiro TAGUCHI, Kawasaki (JP); Naohito TAKAYAMA, Kawasaki (JP); Yasuaki TAKEUCHI, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/715,357

(22) Filed: Mar. 1, 2010

(30) Foreign Application Priority Data
Mar. 2, 2009 (JP) 2009-47975

(51) Int. Cl. H04B 1/04

(52) U.S. Cl. 455/127.1

(57) ABSTRACT

A wireless communication device including an amplifying unit amplifying a transmission signal, a transmission unit configured to transmit the transmission signal amplified through the amplifying unit, a regulating unit configured to regulate a load of the amplifying unit, and a control unit configured to control the regulating unit so that the regulating unit regulates the load of the amplifying unit to attain a load impedance determined based on, a) a power ratio of the transmitted transmission signal to a reflected signal reflected from the transmission unit, and b) at least one of a value of a current passing through the amplifying unit and a gain of the amplifying unit.

### CROSS-REFERENCE TO RELATED APPLICATION

This application is based upon and claims the benefit of priority of the prior Japanese Patent Application No. 2009-47975, filed on Mar. 2, 2009, the entire contents of which are incorporated herein by reference.

### FIELD

Embodiments of the present invention relate to a wireless communication device configured to amplify and transmit a radio-frequency signal including a microwave or the like, which is used for wireless communications.

### BACKGROUND

FIG. 9 illustrates an example of a configuration of a wireless transmission unit of a wireless communication device such as a wireless mobile terminal, a wireless base station device, and so forth in a related art.

FIG. 9 illustrates a modulator 901, a power amplifier (hereinafter often referred to as a “PA”) 902, a direct current-to-direct current (DCDC) converter 903, a directional coupler 904, a baseband unit 905, an isolator 906, a duplexer 907, and an antenna 908.

A transmission signal obtained by modulating a carrier signal, which is transmitted from the modulator 901, is amplified through the PA 902. The DCDC converter 903 supplies power to the PA 902.

The directional coupler 904 is provided between the PA 902 and the isolator 906. The directional coupler 904 transmits part of the transmission signal amplified through the PA 902 to the baseband unit 905 as a monitor signal so that transmission power is monitored.

Further, the transmission signal amplified through the PA 902 is transmitted from the antenna 908 via the isolator 906 and the duplexer 907.

An antenna is often designed to have an impedance of 50 Ω. On the other hand, as wireless communication devices have been downsized and the bandwidths thereof have been increased, the impedance of 50 Ω may not be attained for each of desired frequency bands. Further, when conductive matter exists in the proximity of the antenna, an impedance with a value significantly different from 50 Ω may be attained.

During the design phase, the load of the PA 902 is determined on the assumption that the load would be connected to the impedance of 50 Ω. Consequently, if the impedance value becomes different from 50 Ω as described above, the impedance matching between the antenna and a transfer path is deteriorated, and output power, current consumption, distortion, and so forth may significantly changed, which makes it difficult to obtain a desired characteristic.

On the other hand, a technology of solving the above-described problems through the use of an isolator, as is the case with FIG. 9, has been available. Another example of wireless communication device including an isolator has been disclosed in Japanese Laid-open Patent Publication No. 2004-343419.

Further, a technology of reducing deterioration of the distortion characteristic of an amplifying device without using an isolator has been disclosed in Japanese Laid-open Patent Publication No. 2003-338714, for example.

For example, many isolators have been used for mobile phones, where each of the isolators has an area of 2×2 mm2. In each of mobile phones used in recent years, however, an isolator is provided for each frequency for use at a request to be ready for multiple bands, which may increase the mounting area and the manufacturing cost.

### SUMMARY

According to an aspect of the invention, a wireless communication device includes an amplifying unit amplifying a transmission signal, a transmission unit configured to transmit the transmission signal amplified through the amplifying unit, a regulating unit configured to regulate a load of the amplifying unit, and a control unit configured to control the regulating unit so that the regulating unit regulates the load of the amplifying unit to attain a load impedance determined based on, a) a power ratio of the transmitted transmission signal to a reflected signal reflected from the transmission unit, and b) at least one of a value of a current passing through the amplifying unit and a gain of the amplifying unit.

The objects and advantages of the invention will be realized and attained by means of the elements and combinations particularly pointed out in the claims.

It is to be understood that both the foregoing summary description and the following detailed description are example of and explanatory and are not restrictive of the invention, as claimed.

### BRIEF DESCRIPTION OF DRAWINGS

FIG. 1 illustrates a mode of a wireless transmission unit provided in a wireless communication device according to an embodiment of the present invention;

FIG. 2 illustrates an example of load map illustrating relationships between currents flowing into a PA and a load impedance;

FIG. 3 illustrates an example of load map illustrating relationships between the gains of the PA and the load impedance;

FIG. 4 illustrates a table indicating the load map relating to the currents flowing into the PA;

FIG. 5 illustrates a table indicating the load map relating to the gains of the PA;

FIG. 6 illustrates a flowchart that may be performed to regulate a load impedance according to one embodiment;

FIG. 7 illustrates a flowchart that may be performed to regulate a load impedance according to another embodiment;

FIG. 8 illustrates an example of wireless communication device including a wireless transmission unit according to an embodiment of the present invention; and

FIG. 9 illustrates an example of configuration of a wireless transmission unit of a known wireless communication device.

### DESCRIPTION OF EMBODIMENTS

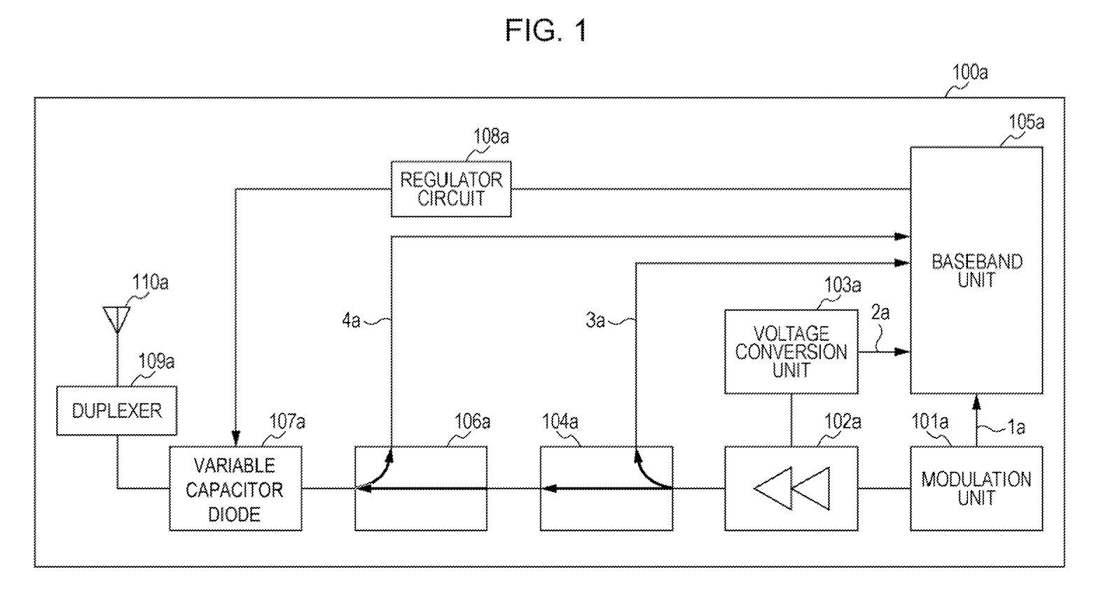

FIG. 1 illustrates a mode of a wireless transmission unit provided in a wireless communication device according to a first embodiment of the present invention.

A wireless transmission unit 100a illustrated in FIG. 1 includes a modulation unit 101a, a power amplifier 102a, a voltage conversion unit 103a, directional couplers 104a and 106a, a baseband unit 105a, a variable capacitance diode 107a, a regulator circuit 108a, a duplexer 109a, and an antenna 110a.

The modulation unit 101a transmits a transmission signal obtained by modulating a carrier signal to the power amplifier (hereinafter referred to as a PA) 102a, and further transmits part of the transmission signal (hereinafter often referred to as a monitor signal 1a) to the baseband unit 105a.

The PA 102a amplifies the transmission signal transmitted from the modulation unit 101a. The PA 102a may support a plurality of frequency bands in accordance with frequency bands used by a wireless communication system. Further, the PA 102a may have a gain adjusting function so as to adjust a gain based on a gain control voltage.

The voltage conversion unit 103a supplies power to the PA 102a. The voltage conversion unit 103a is, for example, a DCDC converter and can convert a power voltage supplied to the PA 102a into a plurality of voltage values. Further, the voltage conversion unit 103a monitors a current flowing into the PA 102a and transmits data of the monitoring result (hereinafter often referred to as a monitor signal 2a) to the baseband unit 105a.

The transmission signal amplified through the PA 102a is transmitted via the variable capacitance diode 107a, the duplexer 109a, and the antenna 110a.

Further, the directional couplers 104a and 106a are provided between the PA 102a and the variable capacitance diode 107a.

The directional coupler 104a extracts part of the transmission signal amplified through the PA 102a as a signal used to monitor transmission power (hereinafter often referred to as a monitor signal 3a), and transmits the monitor signal 3a to the baseband unit 105a.

Further, the directional coupler 106a extracts part of a reflection signal, which is the transmission signal reflected by the antenna 110a, as a signal used to monitor reflected power (hereinafter often referred to as a monitor signal 4a), and transmits the monitor signal 4a to the baseband unit 105a.

Here, a capacitor or the like may be used in place of the directional couplers 104a and 106a.

The baseband unit 105a calculates a voltage standing wave ratio (VSWR) based on the monitor signals 3a and 4a that are transmitted from the individual directional couplers 104a and 106a. Here, the VSWR may be a parameter expressed by the equation VSWR=(1+Γ)/(1−Γ) based on a ratio Γ of transmission power to reflected power. The VSWR may be calculated based on the expression (√transmission power+√reflected power)/(√transmission power−√reflected power).

Further, the baseband unit 105a calculates the gain of the PA 102a, that is, (power transmitted from the PA 102a)−(power transmitted from the modulation unit 101a) based on the monitor signal 1a transmitted from the modulation unit 101a and the monitor signal 3a transmitted from the directional coupler 104a.

The baseband unit 105a stores data of correspondences relating to the VSWR, currents flowing into the PA 102a, and the gains of the PA 102a, as memory table data. The baseband unit 105a determines the load impedance of the PA 102a by performing processing procedures illustrated in a flowchart which will be described later based on the correspondences and controls the regulator circuit 108a.

The function of the baseband unit 105a may be achieved through, for example, a central processing unit (CPU) and/or a digital signal processor (DSP).

The regulator circuit 108a is, for example, a digital-to-analog converter (DAC). A control voltage transmitted from the regulator circuit 108a is regulated under the control of the baseband unit 105a.

The variable capacitance diode 107a regulates the load impedance of the PA 102a based on the control voltage transmitted from the regulator circuit 108a. The variable capacitance diode 107a may be provided as a load regulating unit.

Further, the above-described PA 102a may be provided as an amplifying unit, the directional coupler 104a may be provided as a first detecting unit, the directional coupler 106a may be provided as a second detecting unit, the baseband unit 105a may be provided as a control unit, the variable capacitance diode 107a and the regulator circuit 108a may be provided as a regulating unit, and the antenna 110a may be provided as a transmission unit.

Next, a load-impedance determination method according to the above-described embodiment will be described.

According to the above-described embodiment, the load impedance of the PA 102a is determined based on load maps (e.g., smith charts) indicating the relationship between the characteristic of the PA 102a and the load impedance. According to the load maps, the load impedance of the PA 102a may be determined in association with the VSWR calculated based on the ratio of the transmission power to the reflected power, that is, the impedance attained on the antenna side.

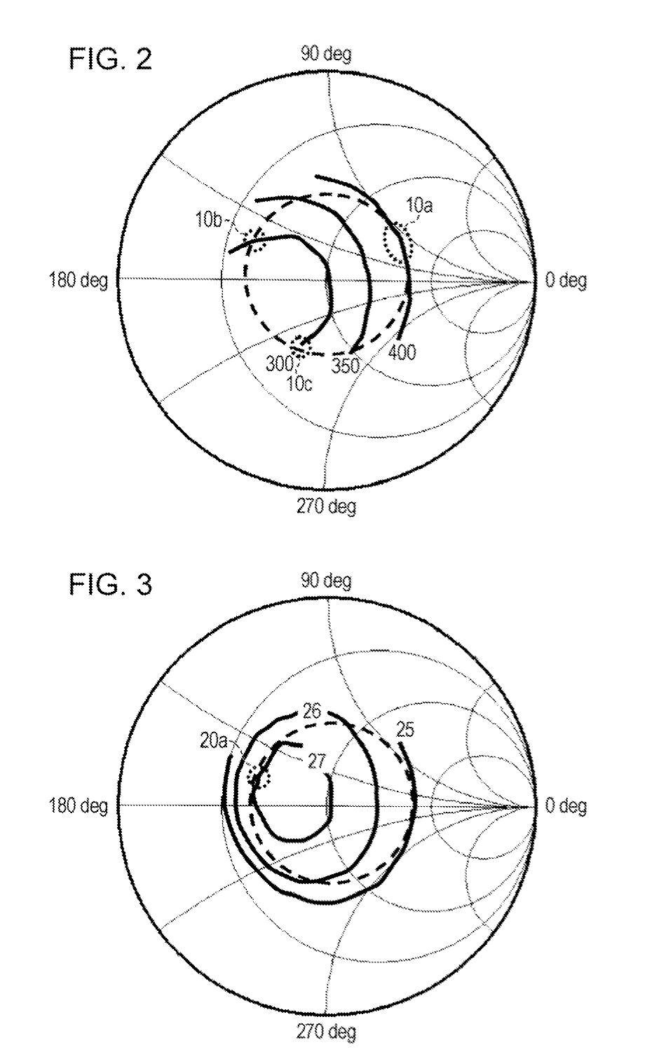

FIG. 2 illustrates an example of load map illustrating the relationship between currents flowing into the PA 102a and the load impedance and FIG. 3 illustrates an example of load map illustrating the relationship between the gains of the PA 102a and the load impedance.

In each of FIGS. 2 and 3, the circle center indicates an ideal matching state where the load impedance value is 50 Ω, which is expressed by the equation VSWR=1, and a broken line indicates the state expressed by the equation VSWR=2.

In FIG. 2, solid lines 300, 350, and 400 indicate the individual states where the currents flowing into the PA 102a are 300 mA, 350 mA, and 400 mA.

For example, when the current flowing into the PA 102a is 400 mA, the broken line and the solid line 400 intersect in a single spot indicated by a dotted line 10a, which indicates that the impedance corresponding to about 30 degrees is attained on the antenna side.

On the other hand, when the current flowing into the PA 102a is 300 mA, the broken line and the solid line 300 intersect in two spots indicated by dotted lines 10b and 10c, which indicates that the impedance corresponding to about 150 degrees and/or the impedance corresponding to about 240 degrees is attained on the antenna side.

That is to say, when the expression VSWR=2 holds and the current flowing into the PA 102a is 400 mA, it may be determined that the load impedance of the PA 102a has a single value based on the value of the current flowing into the PA 102a. However, when the current flowing into the PA 102a is 300 mA, it may be difficult to determine that the load impedance has a single value based only on the value of the current flowing into the PA 102a.

According to the above-described embodiment, therefore, the load impedance value of the PA 102a is determined through the further use of data illustrated in FIG. 3 in the above-described circumstances.

In FIG. 3, solid lines 25, 26, and 27 indicate the individual states where the gains of the PA 102a are 25 dB, 26 dB, and 27 dB.

For example, when the gain of the PA 102a is 27 dB, the broken line and the solid line 27 intersect in a single point indicated by a dotted line 20a, which indicates that the impedance corresponding to about 150 degrees is attained on the antenna side.

Accordingly, when the current flowing into the PA 102a is 300 mA and the gain of the PA 102a is 27 dB, the impedance corresponding to about 150 degrees is attained on the antenna side.

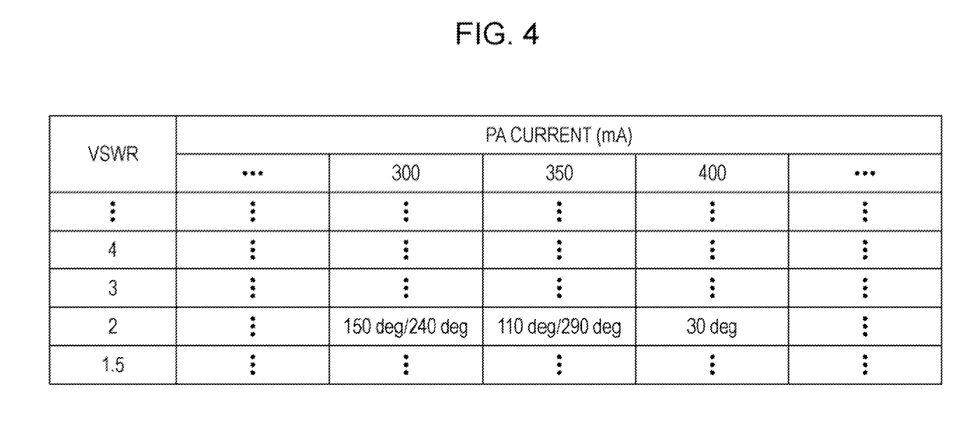

FIG. 4 illustrates a table indicating the load map relating to each of the currents flowing into the PA 102a (expressed as a PA current in FIG. 4), which is illustrated in FIG. 2.

According to FIG. 4, when the expression VSWR=2 holds and the currents flowing into the PA 102a are 300 mA, 350 mA, and 400 mA, for example, the phase conditions corresponding to the individual impedances attained on the antenna side are 150 degrees and/or 240 degrees, 110 degrees and/or 290 degrees, and 30 degrees.

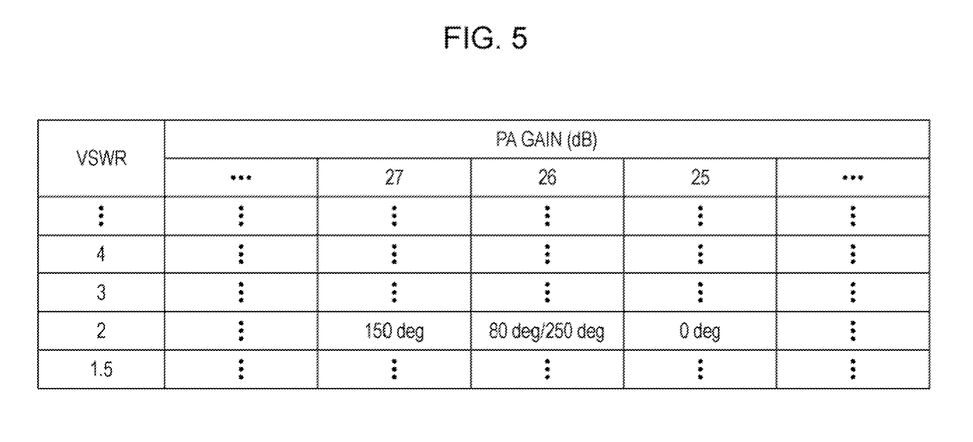

Likewise, FIG. 5 illustrates a table indicating the load map relating to the gains of the PA 102a, which is illustrated in FIG. 3.

According to FIG. 5, when the expression VSWR=2 holds and the gains of the PA 102a are 27 dB, 26 dB, and 25 dB, the phase conditions corresponding to the individual impedances attained on the antenna side are 150 degrees, 80 degrees and/or 250 degrees, and 0 degree.

The baseband unit 105a illustrated in FIG. 1 stores data of the phase conditions corresponding to the VSWR, the currents flowing into the PA 102a, and the gains of the PA 102a that are illustrated in FIGS. 4 and 5 as memory table data. Therefore, the baseband unit 105a refers to the memory table data based on the VSWR, the current flowing into the PA 102a, and the monitor signal relating to the gain of the PA 102a so that an appropriate phase condition may be acquired and a load impedance that should be set to the PA 102a may be determined.

Further, the baseband unit 105a may store data of the phase condition corresponding to the VSWR, the current flowing into the PA 102a, and the gain of the PA 102a that are described above as the memory table data for each of corresponding frequencies of the PA 102a, each of power voltages transmitted to the PA 102a, or each of gain control voltages transmitted to the PA 102a, for example.

Therefore, it may become possible to determine the load impedance of the PA 102a based on the corresponding frequency of the PA 102a, the power voltage transmitted to the PA 102a, or the gain control voltage transmitted to the PA 102a.

Here, each of FIGS. 4 and 5 illustrates an example of table indicating the phase condition corresponding to the VSWR, the current flowing into the PA 102a, and the gain of the PA 102a. The format of each of the tables may be modified so long as the above-described functions are achieved.

Further, the baseband unit 105a may store data of the load impedance value calculated based on the phase condition corresponding to the VSWR, the current flowing into the PA 102a, and the gain of the PA 102a. Further, the baseband unit 105a may store data of both the above-described phase condition and load impedance value.

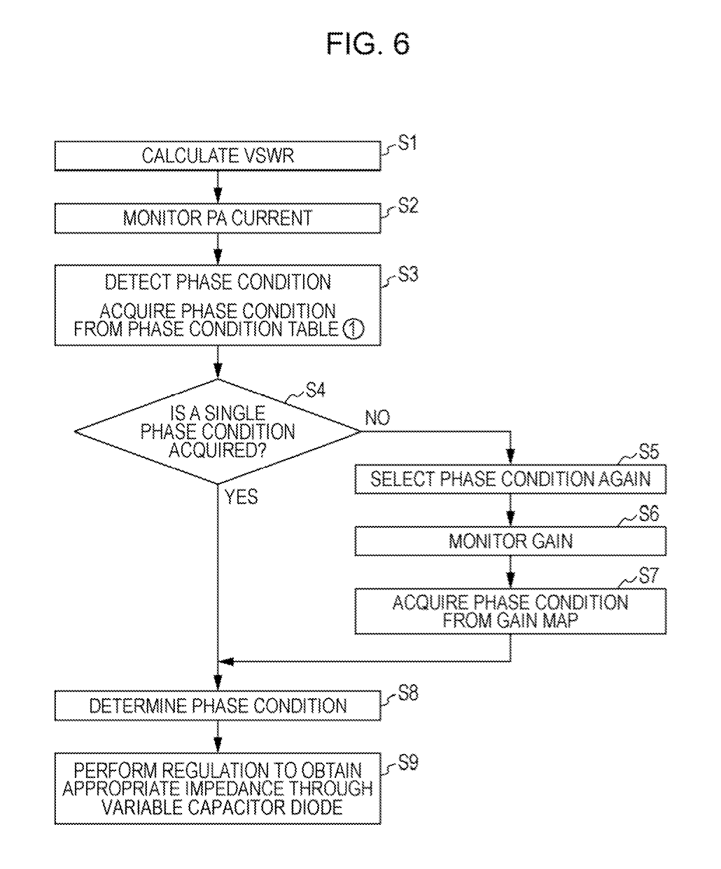

FIG. 6 illustrates a flowchart for regulating the load impedance according to the above-described embodiment.

The baseband unit 105a calculates the VSWR based on the monitor signal 3a transmitted from the directional coupler 104a and the monitor signal 4a transmitted from the directional coupler 106a (S1).

The baseband unit 105a detects the value of the current flowing into the PA 102a based on the monitor signal 2a transmitted from the voltage conversion unit 103a (S2).

The order in which the processing procedures corresponding to S1 and S2 are performed may be reversed.

The baseband unit 105a refers to the memory table data illustrated in FIG. 4 and acquires data of the phase condition corresponding to the VSWR calculated at S1 and the value of the current flowing into the PA 102a, the value being detected at S2 (S3).

The baseband unit 105a determines whether or not the phase condition data acquired at S3 has a single value (S4).

When it is determined that the phase condition data acquired at S3 has a single value (when the answer is YES at S4), the baseband unit 105a determines to use the phase condition data so as to regulate the load impedance of the PA 102a (S8).

If it is determined that the phase condition data acquired at S3 has at least two values (when the answer is NO at S4), the baseband unit 105a acquires the phase condition data again (S5).

The baseband unit 105a calculates the gain of the PA 102a based on the monitor signal 1a transmitted from the modulation unit 101a and the monitor signal 3a transmitted from the directional coupler 104a (S6).

The baseband unit 105a refers to the memory table data illustrated in FIG. 5 and acquires the phase condition data corresponding to the VSWR calculated at S1 and the gain of the PA 102a, the gain being calculated at S6 (S7).

The baseband unit 105a determines the phase condition data used to regulate the load impedance of the PA 102a based on the phase condition data acquired at S3 and that acquired at S7 (S8).

The variable capacitance diode 107a regulates the load impedance of the PA 102a based on an output voltage of the regulator circuit 108a, where the output voltage is regulated under the control of the baseband unit 105a, the control being performed in accordance with the phase condition data determined at step S8.

Thus, according to the above-described embodiment, the wireless communication unit sets the load impedance of the PA 102a based on the impedance attained on the antenna side. Therefore, it may become possible to obtain a desired PA characteristic even though the impedance attained on the antenna side is changed due to an external factor. Further, the above-described effects may be attained without using the isolator.

Further, when it is difficult for the wireless transmission unit to determine a single phase condition by referring to the power ratio of the transmission signal to the reflected signal and the value of the current flowing into the PA 102a, the wireless transmission unit determines the phase condition by referring to the result of monitoring the gain of the PA 102a in addition to the above-described data. Consequently, the load impedance of the PA 102a may be set with precision based on the impedance attained on the antenna side.

The configuration of a second embodiment is substantially the same as that of the first embodiment illustrated in FIG. 1 except for the determining the load impedance through the baseband unit 105a.

In the first embodiment, the baseband unit 105a determines the phase condition by monitoring the current flowing into the PA 102a and/or the current flowing into the PA 102a and the gain of the PA 102a. On the other hand, in the second embodiment, the baseband unit 105a determines the phase condition by monitoring the gain of the PA 102a and/or the gain of the PA 102a and the current flowing into the PA 102a.

The baseband unit 105a calculates the VSWR based on the monitor signals 3a and 4a that are transmitted from the individual directional couplers 104a and 106a (S10).

The baseband unit 105a calculates the gain of the PA 102a based on the monitor signal 1a transmitted from the modulation unit 101a and the monitor signal 3a transmitted from the directional coupler 104a (S11).

The order in which the processing procedures corresponding to S10 and S11 are performed may be reversed.

The baseband unit 105a refers to the memory table data illustrated in FIG. 5 and acquires the phase condition data corresponding to the VSWR calculated at S10 and the gain of the PA 102a, the gain being calculated at step S11 (S12).

The baseband unit 105a determines whether or not the phase condition data acquired at S12 has a single value (S13).

If it is determined that the phase condition data acquired at S12 has the single value (when the answer is YES at S13), the baseband unit 105a determines to use the phase condition data so as to regulate the load impedance of the PA 102a (S17).

If it is determined that the phase condition data acquired at S12 has at least two values (when the answer is NO at step S13), the baseband unit 105a acquires the phase condition data again (S14).

The baseband unit 105a detects the value of the current flowing into the PA 102a based on the monitor signal 2a transmitted from the voltage conversion unit 103a (S15).

The baseband unit 105a refers to the memory table data illustrated in FIG. 4 and acquires the phase condition data corresponding to the VSWR calculated at S10 and the value of the current flowing into the PA 102a, the current value being detected at S15 (S16).

The baseband unit 105a determines the phase condition data used to regulate the load impedance of the PA 102a based on the phase condition data acquired at step S12 and that acquired at S16 (S17).

The variable capacitance diode 107a regulates the load impedance of the PA 102a based on an output voltage of the regulator circuit 108a, where the output voltage is regulated under the control of the baseband unit 105a, the control being performed based on the phase condition data determined at step S17.

Thus, according to the above-described embodiment, the wireless communication unit sets the load impedance of the PA 102a based on the impedance attained on the antenna side. Therefore, it may become possible to obtain a desired PA characteristic even though the impedance attained on the antenna side is changed due to an external factor. Further, the above-described effects may be attained without using the isolator.

Further, when it is difficult for the wireless transmission unit to determine a single phase condition by referring to the power ratio of the transmission signal to the reflected signal and the gain of the PA 102a, the wireless transmission unit determines the phase condition by referring to the result of monitoring the current flowing into the PA 102a in addition to the above-described data. Consequently, the load impedance of the PA 102a may be set with precision based on the impedance attained on the antenna side.

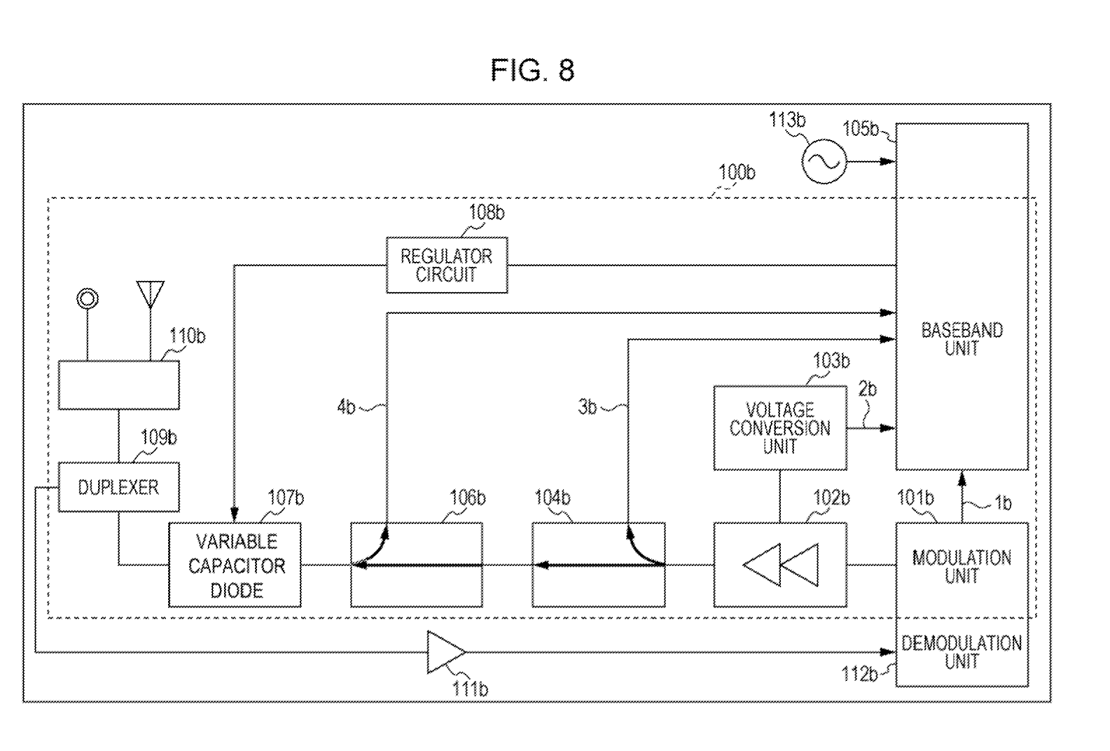

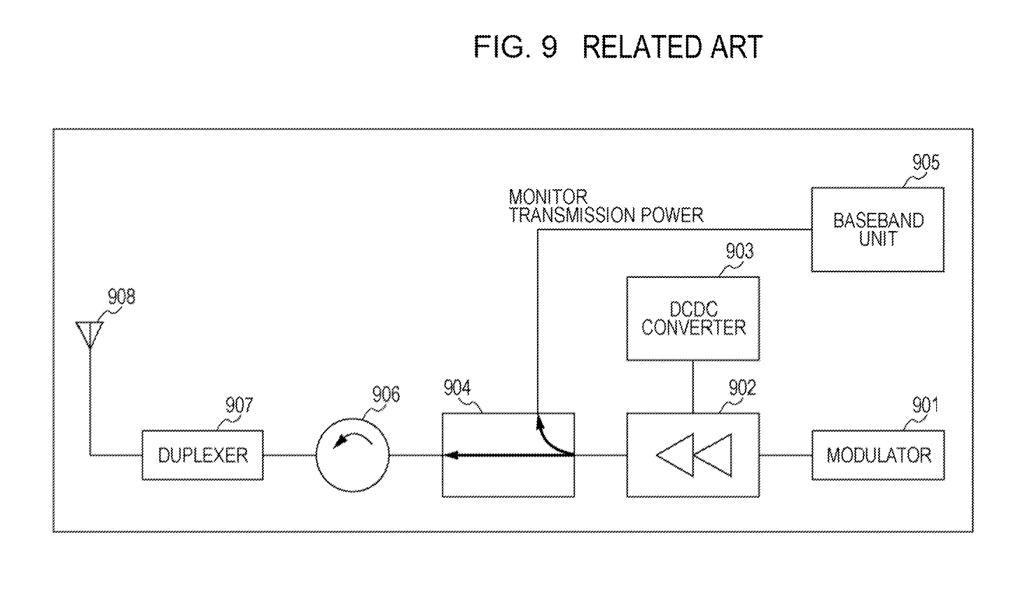

FIG. 8 illustrates an example of wireless communication device according to an embodiment of the present invention. The example of wireless communication device may be, for example, a wireless mobile terminal and/or a wireless base station device.

A wireless transmission unit 100b illustrated in FIG. 8 corresponds to the wireless transmission unit 100a illustrated in FIG. 1.

FIG. 8 illustrates a modulation unit 101b, a power amplifier 102b, a voltage conversion unit 103b, directional couplers 104b and 106b, a baseband unit 105b, a variable capacitance diode 107b, a regulator circuit 108b, a duplexer 109b, an antenna 110b, a low noise amplifier (LNA) 111b, a demodulation unit 112b, and an oscillator 113b.

The modulation unit 101b transmits a transmission signal obtained by modulating a carrier signal to the PA 102b, and further transmits part of the transmission signal (a monitor signal 1b) to the baseband unit 105b.

The PA 102b amplifies the transmission signal transmitted from the modulation unit 101b. The PA 102b may support a plurality of frequency bands in accordance with frequency bands used by the wireless communication system. Further, the PA 102b may have a gain adjusting function so as to adjust a gain based on a control voltage.

The voltage conversion unit 103b supplies power to the PA 102b. The voltage conversion unit 103b is, for example, a DCDC converter and may convert a power voltage supplied to the PA 102b into a plurality of voltage values. Further, the voltage conversion unit 103b monitors a current flowing into the PA 102b and transmits data of the monitoring result (a monitor signal 2b) to the baseband unit 105b.

The transmission signal amplified through the PA 102b is transmitted via the variable capacitance diode 107b, the duplexer 109b, and the antenna 110b.

Further, the directional couplers 104b and 106b are provided between the PA 102b and the variable capacitance diode 107b.

The directional coupler 104b extracts part of the transmission signal amplified through the PA 102b as a signal used to monitor transmission power (a monitor signal 3b), and transmits the monitor signal 3b to the baseband unit 105b.

Further, the directional coupler 106b extracts part of a reflection signal, which is the transmission signal reflected by the antenna 110b, as a signal used to monitor reflected power (a monitor signal 4b), and transmits the monitor signal 4b to the baseband unit 105b.

Here, a capacitor or the like may be used in place of the directional couplers 104b and 106b.

The baseband unit 105b calculates the VSWR based on the monitor signals 3b and 4b that are transmitted from the individual directional couplers 104b and 106b.

Further, the baseband unit 105b calculates the gain of the PA 102a based on the monitor signal 1b transmitted from the modulation unit 101b and the monitor signal 3b transmitted from the directional coupler 104b.

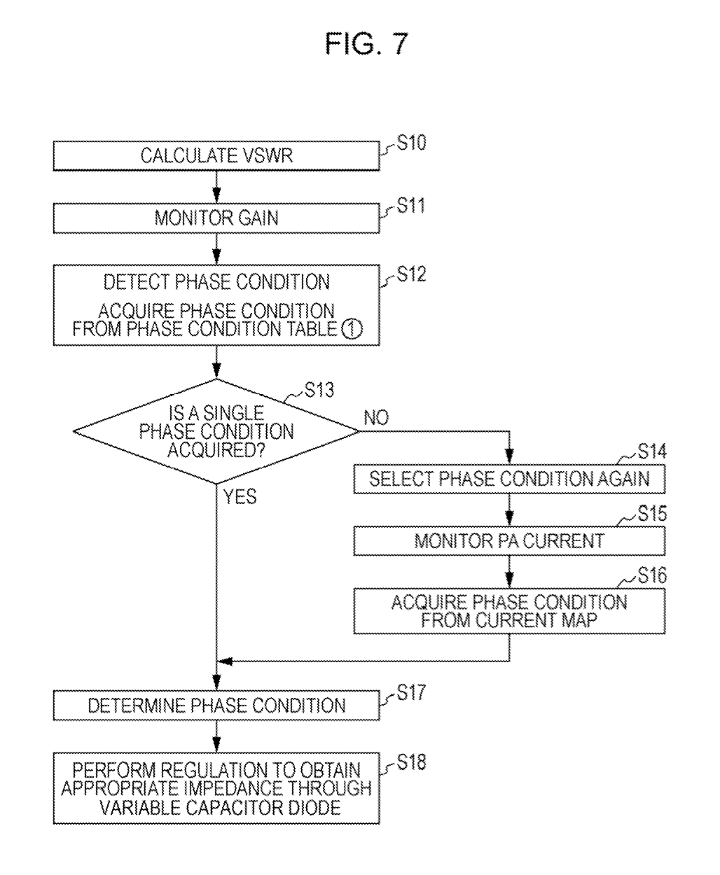

The baseband unit 105b stores data of correspondences relating to the VSWR, currents flowing into the PA 102b, and the gains of the PA 102b, as the memory table data illustrated in each of FIGS. 4 and 5. The baseband unit 105b determines the load impedance of the PA 102b by performing processing procedures illustrated in the flowcharts illustrated in FIGS. 6 and 7, for example, based on the correspondences, and controls the regulator circuit 108b.

A control voltage transmitted from the regulator circuit 108b is regulated under the control of the baseband unit 105b.

The variable capacitance diode 107b regulates the load impedance of the PA 102b based on the control voltage transmitted from the regulator circuit 108b. The variable capacitance diode 107b may be provided as a load regulating unit.

A wireless signal is transmitted to the antenna 110b (which may include a test terminal). The transmitted wireless signal is transmitted to the demodulation unit 112b for demodulation via the duplexer 109b and the LNA 111b.

Further, the above-described PA 102b may be provided as an amplifying unit, the directional coupler 104b may be provided as a first detecting unit, the directional coupler 106b may be provided as a second detecting unit, the baseband unit 105b may be provided as a control unit, the variable capacitance diode 107b and the regulator circuit 108b may be provided as a regulating unit, and the antenna 110b may be provided as a transmission unit.

According to another example, the wireless communication device is a device including at least an amplifier unit and a load regulating unit.

Thus, according to various examples of the above-described embodiment, the wireless communication device allows for setting the load impedance of a PA with precision based on an impedance attained on the antenna side so that a desired PA characteristic may be obtained even though the impedance attained on the antenna side is changed due to an external factor. Further, the above-described effects may be achieved without using an isolator.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A wireless communication device comprising:
an amplifying unit amplifying a transmission signal;
a transmission unit configured to transmit the transmission signal amplified through the amplifying unit;
a regulating unit configured to regulate a load of the amplifying unit; and
a control unit configured to control the regulating unit so that the regulating unit regulates the load of the amplifying unit to attain a load impedance determined based on,
a) a power ratio of the transmitted transmission signal to a reflected signal reflected from the transmission unit, and
b) at least one of a value of a current passing through the amplifying unit and a gain of the amplifying unit.

2. The wireless communication device according to claim 1, further comprising:
a first detecting unit configured to detect power of the transmission signal to be transmitted from the transmission unit; and
a second detecting unit configured to detect power of the reflected signal reflected from the transmission signal.

3. The wireless communication device according to claim 2,
wherein the control unit includes data of a memory table provided to store data of a condition determining a load impedance corresponding to each of the value of the current passing through the amplifying unit or the gain of the amplifying unit for each power ratio of the transmission signal transmitted from the transmission unit to the reflected signal reflected from the transmission unit. and
wherein the control unit controls the regulating unit so that the regulating unit regulates the load of the amplifying unit based on a ratio of the power of the transmission signal, which is being detected through the first detecting unit, to the power of the reflected signal, which is being detected through the second detecting unit, so as to attain an impedance determined based on the condition corresponding to the value of the current passing through the amplifying unit or the condition corresponding to the gain of the amplifying unit.

4. The wireless communication device according to claim 3, wherein the control unit includes the memory table data for each frequency of the transmission signal.

5. The wireless communication device according to claim 3, wherein the control unit includes the memory table data for each power voltage transmitted to the amplifying unit.

6. The wireless communication device according to claim 3, wherein the control unit includes the memory table data for each gain control voltage transmitted to the amplifying unit.

7. The wireless communication device according to claim 3, wherein the condition is a phase condition corresponding to the load impedance.

8. A wireless communication device comprising:
an amplifying unit configured to amplify a transmission signal; and
a regulating unit configured to regulate a load of the amplifying unit,
wherein the regulating unit regulates the load of the amplifying unit so as to attain a load impedance determined based on,
a) a power ratio of the transmission signal that is amplified through the amplifying unit and that is transmitted from an antenna to a reflected signal reflected by the antenna, and
b) at least one of a value of a current passing through the amplifying unit and a gain of the amplifying unit.

9. The wireless communication device of claim 4, wherein the wireless communication device is a wireless mobile terminal or a wireless base terminal.

10. The wireless communication device of claim 8, wherein the wireless communication device is a wireless mobile terminal or a wireless base terminal.

11. A method for amplifying a transmission signal using an amplifying unit in wireless communication device, the method comprising:
amplifying a transmission signal;
transmitting the amplified transmission signal;
regulating a load of the amplifying unit to attain a load impedance determined based on,
a) a power ratio of the transmission signal that is amplified through the amplifying unit and that is transmitted from an antenna to a reflected signal reflected by the antenna, and
b) at least one of a value of a current passing through the amplifying unit and a gain of the amplifying unit.
